(19) United States
(12) Patent Application Publication
(10) Pub. No.: US 2022/0004832 A1
(43) Pub. Date: Jan. 6, 2022

(54) BRAND-IDENTIFIABLE AND CLOUD-ENABLED PACKAGING MATERIAL

(71) Applicant: Cryovac, LLC, Charlotte, NC (US)

(72) Inventors: Edward L. Doheny, II, Charlotte, NC (US); Jason Brummett, Belmont, NC (US); Gregory E. McDonald, Marvin, NC (US); David Orr, Huntersville, NC (US); Michael L. Becraft, Charlotte, NC (US); Christopher Scott, Raleigh, NC (US); Andreas C. Schmidt, Charlotte, NC (US); Ronald L. Cotterman, Charlotte, NC (US)

(21) Appl. No.: 17/293,988

(22) PCT Filed: Nov. 15, 2019
(86) PCT No.: PCT/US2019/061584

§ 371 Date: May 14, 2021

Related U.S. Application Data
(60) Provisional application No. 62/767,738, filed on Nov. 15, 2018.

(51) Int. Cl. G06K 19/06; G06K 7/14; H04W 4/02

(52) U.S. Cl. CPC G06K 19/06103; G06K 19/06028; G06K 7/1439; G06K 2007/10504; G06K 7/1417; H04W 4/023; G06K 7/1413

(57) ABSTRACT

A computing device can facilitate disposal of packaging material. The packaging material can have a product packaged therein. The packaging material includes an identification tag that includes an identifier. A remote computing device reads the identifier from the packaging material and sends a communication that includes the identifier to the computing device. The computing device identifies a location associated with the remote computing device. The computing device determines location-based disposal information for the packaging material that is based at least in part on the location associated with the remote computing device. The computing device send an indication of the location-based disposal information for the packaging material to the remote computing device.

### BACKGROUND

The present disclosure is in the technical field of product packaging. More particularly, the present disclosure is directed to identification of product packaging and using identifiers for tracking the packaged product and/or the packaging material.

Products are packaged in many forms of product packaging for distribution and sale to consumers. Product packaging can include may different forms of material, such as plastics (plastic films, thermoset plastic containers, etc.), paper (e.g., sheet paper, corrugated carboard boxes, etc.), air cellular materials (e.g., BUBBLE WRAP, inflated air pillows, etc.), foam (e.g., closed-cell extruded polystyrene foam), glass, metal, and the like.

Once product have been packaged in packaging material and distributed or sold, it can be difficult to track the packaged product and the packaging material. The packaged product may be bought and sold multiple times through distribution before it reaches a consumer. Once it reaches a consumer, it can be difficult for upstream entities (e.g., manufacturers, packagers, distributers, retailers, etc.) to determine whether the packaged product was actually processed (e.g., manufactured, packaged, distributed, sold, etc.) by the upstream entities. This leaves the customer uncertain of the origin of the packaged product and the upstream entities unable to identify specific products that they processed, such as in the case of a recall. It has been an aim of many manufacturers, retailers, consumers, and other groups to be able to track packaged products through the entire distribution chain in a reliable way.

It has also been an aim of many manufacturers, retailers, consumers, and other groups to encourage proper disposal of product packaging materials to avoid adverse effects to the environment. For example, recycling of product packaging materials is encouraged to avoid offsetting the need for new materials and to deter as much material from entering landfills as possible. Despite efforts to make recycling programs widely available, proper disposal of packaging materials can be a challenge. In particular, proper disposal can be a challenge because consumers are typically in the position to ensure that packaging materials are properly disposed and the proper disposal method for specific materials is often difficult to ascertain for many consumers. Consumers often must choose among multiple different types of recycling programs when disposing of materials, such as municipal recycling (e.g., curbside pickup), retail recycling collection (e.g., recycling collection bins provided at retail stores), or commercial recycling facilities. While consumers may be aware of such programs, it may not be entirely clear to consumers which recycling program is proper for specific types of materials. Some attempts have been made by recycling programs to provide websites where consumers can input a specific type of material to be recycled and their location (e.g., zip code) to obtain information about how to recycle the specific type of material. However, many consumers find such websites to be confusing and cumbersome to use because it is not entirely clear to consumers how the specific type of packaging materials they need to recycle are classified on such websites.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In a first embodiment, a method can be performed of facilitate disposal of packaging material. The method includes providing a packaging material configured to have a product packaged therein. The packaging material includes an identification tag that includes an identifier. The identifier is readable regardless of whether the product is packaged in the packaging material or has been removed from the packaging material. The method further includes receiving, by one or more computing devices from a remote computing device, a communication that includes the identifier read by the remote computing device from the identification tag of the packaging material. The method further includes identifying, by the one or more computing devices, a location associated with the remote computing device. The method further includes determining, by the one or more computing devices, location-based disposal information for the packaging material that is based at least in part on the location associated with the remote computing device. The method further includes sending, from the one or more computing devices to the remote computing device, an indication of the location-based disposal information for the packaging material.

In a second embodiment, the communication received by the one or more computing devices from the remote computing device in the first embodiment includes an indication of the location associated with the remote computing device.

In a third embodiment, the remote computing device of the second embodiment includes a location module and the remote computing device is configured to include the indication of the location in the communication based on a location determined by the location module.

In a fourth embodiment, the remote computing device of any of the second and third embodiments is configured to receive a user input indicative of a location and the remote computing device is configured to include the indication of the location in the communication based on the user input.

In a fifth embodiment, the packaging material in any of the previous embodiments further includes a brand mark proximate to the identification tag.

In a sixth embodiment, the brand mark of the fifth embodiment is associated with a manufacturer of the packaging material.

In a seventh embodiment, at least a portion of the brand mark and a portion of the identification tag in any of the fifth or sixth embodiments overlap each other.

In an eighth embodiment, at least a portion of the brand mark in any of the fifth through seventh embodiments is visible on the packaging material and at least a portion of the identification tag is non-visible.

In a ninth embodiment, the method of any of the previous embodiments further includes sending, from the one or more computing devices to the remote computing device, an indication of a past event associated with at least one of the packaging material or the product.

In a tenth embodiment, wherein the product of the ninth embodiment is a food product and the past event includes one or more of a growing or raising of the food product, a harvesting of the food product, a processing of the food product, a manufacturing of the packaging material, a packaging of the food product inside the packaging material, a maximum storage temperature of the food product, or a recall of the food product.

In an eleventh embodiment, the method of any of the previous embodiments further includes sending, from the one or more computing devices to the remote computing device, an indication of an expected future event associated with at least one of the packaging material or the product.

In a twelfth embodiment, the product of the eleventh embodiment is a food product and the expected future event includes one or more of a sell-by date associated with the food product, a use-by date associated with the food product, a step to prepare the food product for consumption, or a step to prepare the packaging material for recycling.

In a thirteenth embodiment, the location-based disposal information of any of the previous embodiments includes instructions how to recycle the packaging material in the location associated with the remote computing device.

In a fourteenth embodiment, a computer readable storage medium has instructions embodied thereon for facilitating disposal of packaging material. The the packaging material is configured to have a product packaged therein. The packaging material includes an identification tag that includes an identifier. The instructions include instructions that, in response to execution by one or more computing devices, cause the one or more computing devices to: receive, from a remote computing device, a communication that includes the identifier read by the remote computing device from the identification tag of the remote computing device; identify a location associated with the remote computing device; determine location-based disposal information for the packaging material that is based at least in part on the location associated with the remote computing device; and send, to the remote computing device, an indication of the location-based disposal information for the packaging material.

In a fifteenth embodiment, the packaging material of the fourteenth embodiment further includes a brand mark proximate to the identification tag.

In a sixteenth embodiment, the brand mark of the fifteenth embodiment is associated with a manufacturer of the packaging material.

In a seventeenth embodiment, the instructions of any of the fourteenth through sixteenth embodiments further comprise instructions that, in response to execution by the one or more computing devices, further cause the one or more computing devices to send, to the remote computing device, an indication of a past event or an expected future event associated with at least one of the packaging material or the product.

In an eighteenth embodiment, the product of the seventeenth embodiment is a food product and the past event or the expected future event includes one or more of a growing or raising of the food product, a harvesting of the food product, a processing of the food product, a manufacturing of the packaging material, a packaging of the food product inside the packaging material, a maximum storage temperature of the food product, a recall of the food product, a sell-by date associated with the food product, a use-by date associated with the food product, a step to prepare the food product for consumption, or a step to prepare the packaging material for recycling.

In a nineteenth embodiment, the location-based disposal information of any of the fourteenth to eighteenth embodiments includes instructions how to recycle the packaging material in the location associated with the remote computing device.

In a twentieth embodiment, a system can be used to facilitate disposal of packaging material. The packaging material is configured to have a product packaged therein, and wherein the packaging material includes an identification tag that includes an identifier. The system includes one or more processors and one or more memories communicatively coupled to the one or more processors. The one or more memories have instructions stored thereon that, in response to execution by the one or more processors, cause the system to: receive, from a remote computing device, a communication that includes the identifier read by the remote computing device from the identification tag of the remote computing device; identify a location associated with the remote computing device; determine location-based disposal information for the packaging material that is based at least in part on the location associated with the remote computing device; and send, to the remote computing device, an indication of the location-based disposal information for the packaging material.

In a twenty first embodiment, the packaging material of the twentieth embodiment further includes a brand mark proximate to the identification tag.

In a twenty second embodiment, the brand mark of the twenty first embodiment is associated with a manufacturer of the packaging material.

In a twenty third embodiment, the instructions of any of the twentieth to twenty second embodiments further comprise instructions that, in response to execution by the one or more processors, further cause the system to send, to the remote computing device, an indication of a past event or an expected future event associated with at least one of the packaging material or the product.

In a twenty fourth embodiment, the product of the twenty third embodiment is a food product and the past event or the expected future event includes one or more of a growing or raising of the food product, a harvesting of the food product, a processing of the food product, a manufacturing of the packaging material, a packaging of the food product inside the packaging material, a maximum storage temperature of the food product, a recall of the food product, a sell-by date associated with the food product, a use-by date associated with the food product, a step to prepare the food product for consumption, or a step to prepare the packaging material for recycling.

In a twenty fifth embodiment, the location-based disposal information of any of the twentieth to twenty fourth embodiments includes instructions how to recycle the packaging material in the location associated with the remote computing device.

In a twenty sixth embodiment, a packaging material includes a substrate of packaging material, a first identification tag located on the substrate, and a second identification tag location on the substrate. The packaging material is configured to have a product placed therein. The first identification tag is machine-readable using a first manner of detection. The second identification tag is machine-readable using a second manner of detection. Each of the first and second identification tags includes an identifier of at least one of the packaging material or the product.

In a twenty seventh embodiment, the first manner of detection of the twenty sixth embodiment includes detection of electromagnetic energy in a first range of wavelengths and the second manner of detection of the twenty sixth embodiment includes detection of electromagnetic energy in a second range of wavelengths.

In a twenty eighth embodiment, the first range of wavelengths of the twenty seventh embodiment is outside of the visible range of electromagnetic energy and the second range of wavelengths of the twenty seventh embodiment is inside of the visible range of electromagnetic energy.

In a twenty ninth embodiment, each of the first and second range of wavelengths of any of the twenty seventh or twenty eighth embodiments is inside of the visible range of electromagnetic energy and the first range of wavelengths of any of the twenty seventh or twenty eighth embodiments does not overlap the second range of wavelengths.

In a thirtieth embodiment, the packaging material of any of the twenty sixth to twenty ninth embodiments further includes a brand mark located on the substrate in proximity to the first and second identification tags.

In a thirty first embodiment, the first identification tag of the thirtieth embodiment is incorporated into at least a portion of the brand mark.

In a thirty second embodiment, the brand mark of the thirty first embodiment includes at least one of a word mark or a logo.

In a thirty third embodiment, the second identification tag of any of the thirty first or thirty second embodiments includes a plurality of geometric shapes.

In a thirty fourth embodiment, the brand mark of any of the thirtieth to thirty third embodiments is located on the substrate separate from the first and second identification tags.

In a thirty fifth embodiment, the first identification tag of any of the twenty sixth through thirty fourth embodiments includes information encoded in at least one of a barcode or a QR code and the second identification tag of any of the twenty sixth through thirty fourth embodiments includes information encoded in a symbolic code having a plurality of different symbols.

### BRIEF DESCRIPTION OF THE DRAWING

The foregoing aspects and many of the attendant advantages of the disclosed subject matter will become more readily appreciated as the same become better understood by reference to the following detailed description, when taken in conjunction with the accompanying drawings, wherein:

FIG. 1 depicts an embodiment of a brand mark, in accordance with the embodiments described herein;

FIG. 2 depicts an embodiment of the brand mark shown in FIG. 1 being scanned by a scanning device, in accordance with the embodiments described herein;

FIGS. 3A-3D depict embodiments of the results of the scanning device shown in FIG. 2 scanning, at various wavelengths, the substrate with the brand mark shown in FIG. 1, in accordance with the embodiments described herein;

FIG. 4A depicts another embodiment of a brand mark, in accordance with the embodiments described herein;

FIGS. 4B-4D depict embodiments of the results of a scanning device scanning, at various wavelengths, the substrate with the brand mark shown in FIG. 4A, in accordance with the embodiments described herein;

FIGS. 5A-5C depict embodiments of the results of a scanning device scanning, at various wavelengths, the substrate with a brand mark that is a variation of the brandmark shown in FIG. 4A, in accordance with the embodiments described herein;

FIG. 6A depicts an embodiment of a brand mark that has two identification tags located in proximity to the brandmark, in accordance with the embodiments described herein;

FIG. 6B depicts an embodiment of the brand mark shown in FIG. 6A being scanned by a scanning device, in accordance with the embodiments described herein;

FIG. 7 depicts an embodiment of the brand mark and the two identification tags shown in FIG. 6A located on shrink film that packages a piece of meat, in accordance with the embodiments described herein;

FIG. 8 depicts an embodiment of a method of how a packaging material and a packaged product can be identified throughout its lifecycle in a distribution chain, in accordance with the embodiments described herein;

FIG. 9 depicts an embodiment of a method of providing location-based disposal information to a user's computing device in a distribution chain, in accordance with the embodiments described herein;

FIG. 10 depicts an embodiment of a brand mark that has a scan indicator to aid the user in identifying an area to scan, in accordance with the embodiments described herein;

FIG. 11 depicts an example embodiment of a system that may be used to implement some or all of the embodiments described herein; and

FIG. 12 depicts a block diagram of an embodiment of a computing device, in accordance with the embodiments described herein.

### DETAILED DESCRIPTION

The present disclosure describes embodiments of packaging materials that have brand marks and machine-readable identification tags associated therewith. In some embodiments, a brand mark is located in proximity to a non-visible, machine-readable identification tag that can be scanned to obtain information about the packaging material and/or the product packaged within the packaging material. In some embodiments, a brand mark is located in proximity to multiple identification tags that are machine-readable using two different manners of detection, which enable at least one of the identification tags to be read in most circumstances throughout the distribution chain of the packaging material. In some embodiments, the identification tag can be scanned to provide a user with location-based disposal information that enable the user to properly dispose of (e.g., recycle) the packaging material. In other embodiments, the identification tag may, alternatively or in addition to disposal information, provide other types of information about the packaged product from a database, such as a blockchain public ledger.

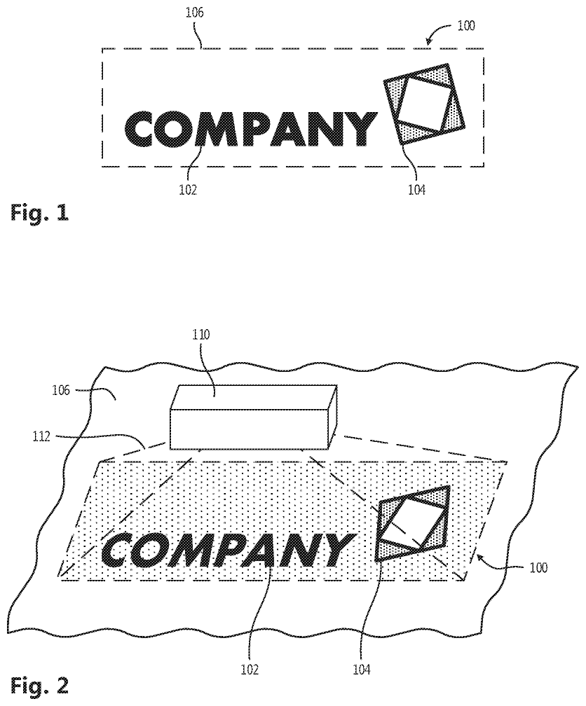

Depicted in FIG. 1 is an embodiment of a brand mark 100. In general, brand marks are intended to aid consumers in identifying manufacturers or suppliers of particular goods and for brand owners to improve their goodwill in the minds of consumers. In the depicted embodiment, the brand mark 100 includes both a word mark 102 and a logo 104. Brand marks may include one or more of word marks, logos, colors, designs, pictures, symbols, fonts or typeface, sounds, or other indicia of the owner of the brand. In the depicted embodiment, the brand mark 100 is located on a substrate 106.

The substrate 106 can be a portion of product packaging that is configured to have a product packaged therein. In some embodiments, the substrate 106 may be a portion of plastic film that is usable to package a product. For example, the substrate 106 can be a shrink film configured to conform to the contour of a product upon heating of the shrink film. In some embodiments, the product is a food product, such as a piece of raw meat, an item of produce (e.g., a vegetable or a fruit), a dairy product (e.g., cheese), and the like. In another example, the substrate 106 may be a non-shrink film configured to be wrapped around a product or around another form of product packaging (e.g., a boxed product). In another example, the substrate 106 may be a paper material, such as a corrugated cardboard.

In some embodiments, the brand mark 100 can also be an identification tag capable of encoding information. In some embodiments, the encoded information can include an identifier of a type of the packaging material, an identifier of the type of product packaged in the packaging material, a unique identifier of the specific packaged product, or any other identification information. As discussed in greater detail below, identification tags include one-dimensional codes (e.g., barcodes), two-dimensional codes (e.g., QR [quick response] codes), symbolic codes, codes readable based on the interrogation wavelength, radio frequency identification (RFID) tags, and the like.

In the embodiment shown in FIG. 2, the brand mark 100 on the substrate 106 is scanned by a scanning device 110. The scanning device 110 is configured to interrogate the substrate 106 and to detect the presence of a readable code on the substrate 106. In the depicted embodiment, the scanning device 110 is configured to interrogate the substrate 106 in a scanning field 112. In some embodiments, the scanning device 110 is configured to read one or more identification tags located on the substrate 106 within the scanning field 112.

In some embodiments, the scanning device 110 is configured to detect electromagnetic energy within specific categories of electromagnetic energy, such as within an ultraviolet range of electromagnetic energy (i.e., having wavelengths in a range from about 10 nanometers to about 400 nanometers), within a visible range of electromagnetic energy (i.e., having wavelengths in a range from about 400 nanometers to about 700 nanometers), within an infrared range of electromagnetic energy (i.e., having wavelengths in a range from about 700 nanometers to about 1 millimeter), within a range of electromagnetic energy having wavelengths shorter than ultraviolet (i.e., having wavelengths less than about 10 nanometers), or within a range of electromagnetic energy having wavelengths longer than infrared (i.e., having wavelengths greater than about 1 millimeter). In some embodiments, the scanning device 110 is configured to detect electromagnetic energy within specific subcategories of electromagnetic energy, such as in subcategories of visible light, including within a range of violet light (i.e., having wavelengths in a range from about 400 nanometers to about 450 nanometers), within a range of blue light (i.e., having wavelengths in a range from about 450 nanometers to about 495 nanometers), within a range of green light (i.e., having wavelengths in a range from about 495 nanometers to about 570 nanometers), within a range of yellow light (i.e., having wavelengths in a range from about 570 nanometers to about 590 nanometers), within a range of orange light (i.e., having wavelengths in a range from about 590 nanometers to about 620 nanometers), or within a range of red light (i.e., having wavelengths in a range from about 620 nanometers to about 700 nanometers).

In some embodiments, the scanning device 110 is configured to detect electromagnetic energy based on the ambient electromagnetic energy around the substrate 106. In some embodiments, the scanning device 110 is configured to emit electromagnetic energy toward the substrate 106 when scanning the substrate 106. In one example, the scanning device 110 emits white light (e.g., light from across the entire visible light spectrum) toward the substrate 106 when scanning the substrate for one or more ranges of wavelengths within the visible spectrum. In some embodiments, the scanning device 110 emits electromagnetic energy at a particular wavelength and detects electromagnetic energy from the substrate at a different wavelength, such as when an identification tag includes a fluorescent material.

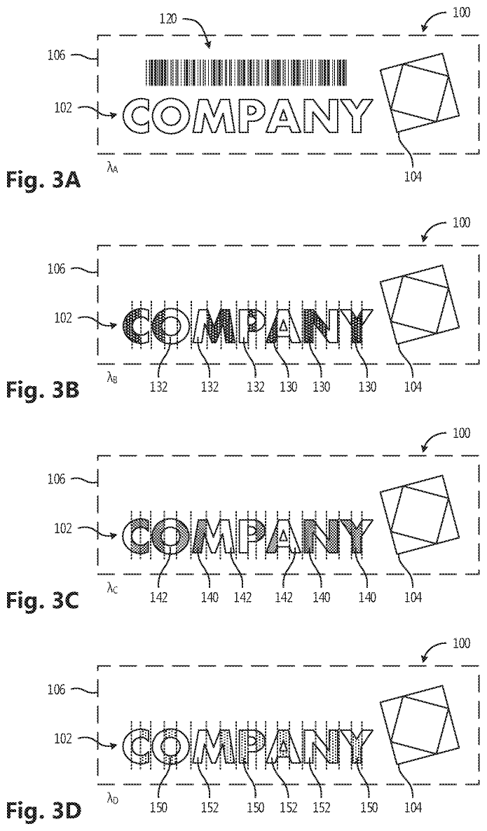

In some instances, the scanning device 110 may detect electromagnetic energy across a range of wavelengths. For example, the scanning device 110 may be a camera that detects electromagnetic energy across the entire visual range. In other instances, the scanning device 110 may detect electromagnetic energy at one or more specific wavelengths. For example, the scanning device 110 may detect one or more specific wavelengths in the ultraviolet range, in the visual range, or in the infrared range. Depicted in FIGS. 3A-3D are embodiments of the results of the scanning device 110 scanning the substrate 106 at four different wavelengths λ_{A}-λ_{D}, respectively. The wavelengths λ_{A}-λ_{D} may be any wavelength of electromagnetic energy. In some embodiments, each of the wavelengths λ_{A}-λ_{D} is a wavelength in one of the ultraviolet range, the visual range, or the infrared range.

FIG. 3A depicts the results of the scanning device 110 scanning the substrate 106 at the wavelength λ_{A}. At the wavelength λ_{A}, the scanning device 110 detects a barcode 120. Once the barcode 120 is detected at the wavelength λ_{A}, the barcode 120 may be readable in the same way that visible barcodes are readable. In some embodiments, the barcode 120 is formed using ink (e.g., a thin layer of ink) that is not visible in the visible range of electromagnetic energy, but may be detectable in ranges outside of the visible range, such as in the ultraviolet or the infrared ranges of electromagnetic energy. In particular, the ink used to form the barcode 120 may be formulated to have the desired spectral response at the wavelength λ_{A}. In the depiction, the outlines of the word mark 102 and the logo 104 are shown for reference; however, in some embodiments, the word mark 102 and the logo 104 may not be detected by the scanning device 110 at the wavelength λ_{A}. It will be noted that the barcode 120 is not integrated into the brand mark 100 (e.g., the barcode 120 is not part of the word mark 102 or the logo 104), but the barcode 120 is in proximity to the brand mark 100 because the scanning of the brand mark 100 at the wavelength λ_{A} would likely detect the barcode 120.

FIG. 3B depicts the results of the scanning device 110 scanning the substrate 106 at the wavelength λ_{B}. At the wavelength λ_{B}, a binary response of portions of the brand mark 100 is detectable. In the depicted embodiment, the word mark 102 has been divided into vertical lanes that appear as either filled lanes 130 or unfilled lanes 132. In the depicted embodiment, the vertical lanes are demarcated by thin, dashed lines for convenience, though such lines may not be marked on the substrate 106 itself. In some embodiments, the portions of the word mark 102 in the filled lanes 130 include an ink that has the desired spectral response to appear filled at the wavelength λ_{B}. In some cases, the ink is not visible in the visible range of electromagnetic energy, but may be detectable in ranges outside of the visible range, such as in the ultraviolet or the infrared ranges of electromagnetic energy. In other cases, the ink may be visible in the visible range at substantially the same color as the entire word mark 102 (e.g., the color that would be visible in the word mark 102 in FIG. 1), while the ink has the desired spectral response to appear filled at the wavelength λ_{B}. It is noted that the barcode 120 is not detectable at the wavelength λ_{B}.

FIG. 3C depicts the results of the scanning device 110 scanning the substrate 106 at the wavelength λ_{C}. At the wavelength λ_{C}, a binary response of portions of the brand mark 100 is detectable. In the depicted embodiment, the word mark 102 has been divided into vertical lanes that appear as either filled lanes 140 or unfilled lanes 142. In the depicted embodiment, the vertical lanes are demarcated by thin, dashed lines for convenience, though such lines may not be marked on the substrate 106 itself. In some embodiments, the portions of the word mark 102 in the filled lanes 140 include an ink that has the desired spectral response to appear filled at the wavelength λ_{C}. In some cases, the ink is not visible in the visible range of electromagnetic energy, but may be detectable in ranges outside of the visible range, such as in the ultraviolet or the infrared ranges of electromagnetic energy. In other cases, the ink may be visible in the visible range at substantially the same color as the entire word mark 102 (e.g., the color that would be visible in the word mark 102 in FIG. 1), while the ink has the desired spectral response to appear filled at the wavelength λ_{C}. It is noted that the barcode 120 is not detectable at the wavelength λ_{C}.

FIG. 3D depicts the results of the scanning device 110 scanning the substrate 106 at the wavelength λ_{D}. At the wavelength λ_{D}, a binary response of portions of the brand mark 100 is detectable. In the depicted embodiment, the word mark 102 has been divided into vertical lanes that appear as either filled lanes 150 or unfilled lanes 152. In the depicted embodiment, the vertical lanes are demarcated by thin, dashed lines for convenience, though such lines may not be marked on the substrate 106 itself. In some embodiments, the portions of the word mark 102 in the filled lanes 150 include an ink that has the desired spectral response to appear filled at the wavelength λ_{D}. In some cases, the ink is not visible in the visible range of electromagnetic energy, but may be detectable in ranges outside of the visible range, such as in the ultraviolet or the infrared ranges of electromagnetic energy. In other cases, the ink may be visible in the visible range at substantially the same color as the entire word mark 102 (e.g., the color that would be visible in the word mark 102 in FIG. 1), while the ink has the desired spectral response to appear filled at the wavelength λ_{D}. It is noted that the barcode 120 is not detectable at the wavelength λ_{D}.

The combinations of filled and unfilled lanes in each of FIGS. 3B-3D may encode information. For example, the combination of filled lanes 130 and unfilled lanes 132 that are detectable at the wavelength λ_{B} may encode a first set of information, the combination of filled lanes 140 and unfilled lanes 142 that are detectable at the wavelength λ_{C} may encode a second set of information, and the combination of filled lanes 150 and unfilled lanes 152 that are detectable at the wavelength λ_{D} may encode a third set of information. This may allow a particular group of users (e.g., packers and manufacturers) to obtain the first set of information relevant to that group, another particular group of users (e.g., distributors and retailers) to obtain the second set of information relevant to that group, and yet another group of users (e.g., consumers) to obtain the third set of information relevant to that group. In another example, the combination of filled lanes 130, 140, and 150, and the unfilled lanes 132, 142, and 152 may together encode a single set of information. This may be desirable with complex or large sets of information that is encoded in the brand mark 100.

In FIGS. 3B-3D, each of the set of filled lanes 130 and unfilled lanes 132, the set of filled lanes 140 and unfilled lanes 142, and the set of filled lanes 150 and unfilled lanes 152 represents an identification tag that is incorporated into the brand mark 100. One advantage to incorporating identification tags into brand marks is that the brand mark itself can define the orientation and length of the encoding. For example, the scanning device 110 may recognize the orientation and position of the word mark 102 when scanning the substrate 106 so that the beginning, ending, and orientation of any code integrated into the word mark 102 is known. In this way, the identification tags integrated into the brand mark 100 need not have start and stop delimiters (as is common in one-dimensional codes) or positioning or alignment markings (as is common in two-dimensional codes). In the depicted embodiments, each of the set of filled lanes 130 and unfilled lanes 132, the set of filled lanes 140 and unfilled lanes 142, and the set of filled lanes 150 and unfilled lanes 152 includes 21 vertical lanes. With a binary response (e.g., filled or unfilled), there are over two million possible combinations that can be encoded by each of the set of filled lanes 130 and unfilled lanes 132, the set of filled lanes 140 and unfilled lanes 142, and the set of filled lanes 150 and unfilled lanes 152. While the example depicted here shows codes readable at three different wavelengths, it will be understood that codes can be read in the brand mark 100 at any number of wavelengths.

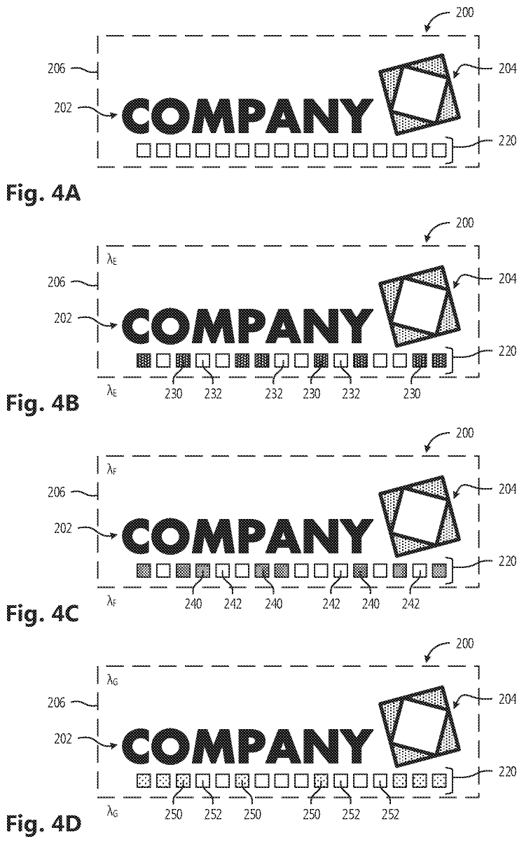

Depicted in FIG. 4A is another embodiment of a brand mark 200. In the depicted embodiment, the brand mark 200 includes both a word mark 202 and a logo 204. In the depicted embodiment, the brand mark 200 is located on a substrate 206. The substrate 206 can be a portion of product packaging that is configured to have a product packaged therein.

In the depicted embodiment, an identification tag 220 is also located on the substrate 206 in proximity to the brand mark 200. The identification tag 220 is capable of encoding information. In some embodiment, the identification tag 220 includes a number of geometric shapes. In the specific embodiment depicted in FIG. 4A, the identification tag 220 includes sixteen squares below the brand mark 200. It other embodiments, the identification tag 220 can include any other number of geometric shapes, can have a different geometric shape (e.g., circles), can have irregular geometric shapes (e.g., irregular polygons), can include a number of different geometric shapes, or any other variation.

FIG. 4A depicts the brand mark 200 and the identification tag 220 as might be visible in the visible spectrum to a viewer. In particular, the geometric shapes in the identification tag 220 may appear to be substantially uniform when viewed by a viewer. The portion of the substrate 206 with the brand mark 200 and the identification tag 220 can be scanned by a scanning device (e.g., the scanning device 110 or any other type of scanning device). Depicted in FIGS. 4B-4D are embodiments of the results of the scanning device scanning the substrate 206 at three different wavelengths λ_{E}-λ_{G}, respectively. The wavelengths λ_{E}-λ_{G} may be any wavelength of electromagnetic energy. In some embodiments, each of the wavelengths λ_{E}-λ_{G} is a wavelength in one of the ultraviolet range, the visual range, or the infrared range.

FIG. 4B depicts the results of the scanning device scanning the substrate 206 at the wavelength λ_{E}. At the wavelength λ_{E}, a binary response in the geometric shapes of the identification tag 220 is detectable. In the depicted embodiment, some of the geometric shapes appear as filled shapes 230 and others of the geometric shapes appear as unfilled shapes 232. In some embodiments, the geometric shapes that appear as filled shapes 230 at wavelength λ_{E} include an ink that has the desired spectral response to appear filled at the wavelength λ_{E}. In some cases, the ink is not visible in the visible range of electromagnetic energy, but may be detectable in ranges outside of the visible range, such as in the ultraviolet or the infrared ranges of electromagnetic energy. In other cases, the ink may be visible in the visible range at substantially the same color as the geometric shapes that are unfilled shapes 232 at wavelength λ_{E} (e.g., the color that would be visible in all of the geometric shapes of the identification tag 220 in FIG. 4A), while the ink has the desired spectral response to appear filled at the wavelength λ_{E}.

FIG. 4C depicts the results of the scanning device scanning the substrate 206 at the wavelength λ_{F}. At the wavelength λ_{F}, a binary response in the geometric shapes of the identification tag 220 is detectable. In the depicted embodiment, some of the geometric shapes appear as filled shapes 240 and others of the geometric shapes appear as unfilled shapes 242. In some embodiments, the geometric shapes that appear as filled shapes 240 at wavelength λ_{F} include an ink that has the desired spectral response to appear filled at the wavelength λ_{F}. In some cases, the ink is not visible in the visible range of electromagnetic energy, but may be detectable in ranges outside of the visible range, such as in the ultraviolet or the infrared ranges of electromagnetic energy. In other cases, the ink may be visible in the visible range at substantially the same color as the geometric shapes that are unfilled shapes 242 at wavelength λ_{F} (e.g., the color that would be visible in all of the geometric shapes of the identification tag 220 in FIG. 4A), while the ink has the desired spectral response to appear filled at the wavelength λ_{F}.

FIG. 4D depicts the results of the scanning device scanning the substrate 206 at the wavelength λ_{G}. At the wavelength λ_{G}, a binary response in the geometric shapes of the identification tag 220 is detectable. In the depicted embodiment, some of the geometric shapes appear as filled shapes 250 and others of the geometric shapes appear as unfilled shapes 252. In some embodiments, the geometric shapes that appear as filled shapes 250 at wavelength λ_{G} include an ink that has the desired spectral response to appear filled at the wavelength λ_{G}. In some cases, the ink is not visible in the visible range of electromagnetic energy, but may be detectable in ranges outside of the visible range, such as in the ultraviolet or the infrared ranges of electromagnetic energy. In other cases, the ink may be visible in the visible range at substantially the same color as the geometric shapes that are unfilled shapes 252 at wavelength λ_{G} (e.g., the color that would be visible in all of the geometric shapes of the identification tag 220 in FIG. 4A), while the ink has the desired spectral response to appear filled at the wavelength λ_{G}.

The combinations of filled and unfilled shapes in each of FIGS. 4B-4D may encode information. For example, the combination of filled shapes 230 and unfilled shapes 232 that are detectable at the wavelength λ_{E} may encode a first set of information, the combination of filled shapes 240 and unfilled shapes 242 that are detectable at the wavelength λ_{F} may encode a second set of information, and the combination of filled shapes 250 and unfilled shapes 252 that are detectable at the wavelength λ_{F} may encode a third set of information. This may allow a particular group of users (e.g., packers and manufacturers) to obtain the first set of information relevant to that group, another particular group of users (e.g., distributors and retailers) to obtain the second set of information relevant to that group, and yet another group of users (e.g., consumers) to obtain the third set of information relevant to that group. In another example, the combination of filled shapes 230, 240, and 250, and the unfilled shapes 232, 242, and 252 may together encode a single set of information. This may be desirable with complex or large sets of information that is encoded in the identification tag 220.

In FIGS. 4A-4D, the identification tag 220 is located in proximity to the brand mark 200. One advantage to locating the identification tag 220 in proximity to the brand mark is that the brand mark itself can define the orientation and length of the encoding. For example, in the depicted embodiment, the scanning device may recognize that the geometric shape closest to the start of the word mark 202 is the beginning of the code and geometric shape that is closest to the end of the logo 204 is the end of the code. In this way, the beginning, ending, and orientation of the identification code is known based on its proximity to the brand mark 200. In this way, the identification tag 220 not have start and stop delimiters (as is common in one-dimensional codes) or positioning or alignment markings (as is common is two-dimensional codes). In the depicted embodiments, each of the set of filled shapes 230 and unfilled shapes 232, the set of filled shapes 240 and unfilled shapes 242, and the set of filled shapes 250 and unfilled shapes 252 includes sixteen geometric shapes. With a binary response (e.g., filled or unfilled) for sixteen shapes, there are over sixty five thousand possible combinations (2¹⁶ combinations) that can be encoded by each of the set of filled shapes 230 and unfilled shapes 232, the set of filled shapes 240 and unfilled shapes 242, and the set of filled shapes 250 and unfilled shapes 252. While the example depicted here shows codes readable at three different wavelengths, it will be understood that codes can be read in the identification tag 220 at any number of wavelengths.

While some of the embodiments described herein include non-visible identification tags that can be scanned and/or detected at wavelengths outside of the visible range of electromagnetic energy, it will be understood that identification tags can be non-visible in other ways. In some embodiments, identification tags can be printed on a substrate using lenticular printing. Lenticular printing can make the identification tag non-visible when viewing the substrate at certain angles and visible when viewing the substrate at other angles. For example, lenticular printing of an identification tag on a surface may make the identification tag non-visible when viewing the substrate at a steep angle (e.g., when the viewing angle is substantially perpendicular to the substrate) and visible when viewing the substrate at a shallow angle (e.g., when the viewing angle is at or below 45° with respect to the substrate). In some embodiments, a steep angle when viewing a substrate is any angle that is greater than or equal to at least one of 30°, 45°, 60°, or 75°. In some embodiments, a shallow angle when viewing a substrate is any angle that is less than or equal to at least one of 60°, 45°, 30°, or 15°. In other embodiments, identification tags can be made non-visible using any manner of printing, surface treatment, type of ink, any other technique, or combinations thereof.

In some instances, it may be advantageous for more than one identification tag to be located on a substrate in proximity to each other. In one example of having multiple identification tags, it may be advantageous in some instances to provide one identification tag that is machine-readable using a common manner of detection and another identification tag that is machine-readable using a less common manner of detection. An identification tag that is readable using a more common method of detection (e.g., a barcode or a QR code that are readable with common barcode reader, smart phones, etc.) can enable many users to scan the identification tag and obtain the information encoded therein. An identification tag that is readable using a less common method of detection (e.g., scanning codes integrated into brand marks at specific wavelengths) can limit reading of the information encoded therein to a few users who have such scanning capabilities. In another example of having multiple identification tags, it may be advantageous in some instances to have one identification tag that can be read more easily than the other identification tag. For example, it may be advantageous in an environment where packaged products are moving quickly (e.g., in a packaging plant) to have an identification code that can be read even when the packaged product is moving quickly, but to also have another identification tag that can be read in other environments where the packaged product is not moving quickly (e.g., in a retail store, at a consumer's residence, etc.). In these cases, the identification tag that can be read more easily may encode as much information as is necessary for those environments where it will be read, while the identification tag that can be read less easily may encode more information that will be useful in other environments.

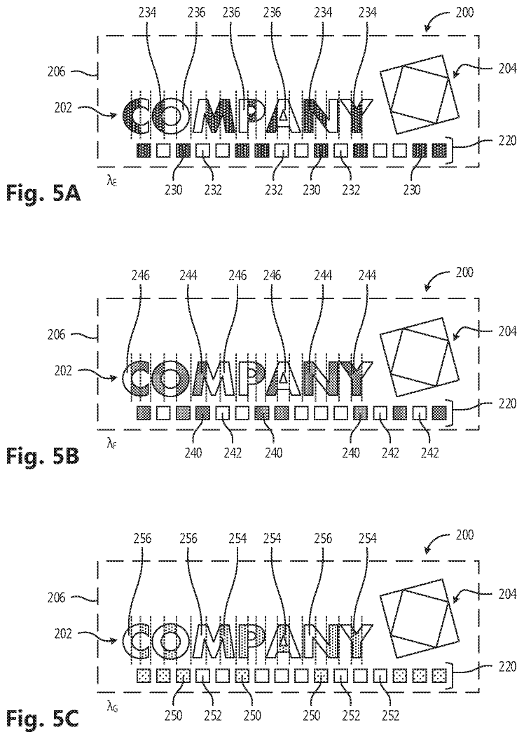

FIGS. 5A-5C depict a variation of the brand mark 200 and the identification tag 220 shown in FIGS. 4A-4D. In FIGS. 5A-5C, in addition to the identification tag 220, another identification tag has been incorporated into the brand mark 200. Depicted in FIGS. 5A-5C are embodiments of the results of the scanning device scanning the substrate 206 at the wavelengths λ_{E}-λ_{G}, respectively.

FIG. 5A depicts the results of the scanning device scanning the substrate 206 at the wavelength λ_{E}. The identification tag 220 has responded in the same manner shown in FIG. 4B with the geometric shapes of the identification tag 220 appearing as filled shapes 230 and unfilled shapes 232. At the wavelength λ_{E}, a binary response of portions of the word mark 202 is detectable. In the depicted embodiment, the word mark 202 has been divided into vertical lanes that appear as either filled lanes 234 or unfilled lanes 236. In the depicted embodiment, the vertical lanes are demarcated by thin, dashed lines for convenience, though such lines may not be marked on the substrate 206 itself. In some embodiments, the portions of the word mark 202 in the filled lanes 234 include an ink that has the desired spectral response to appear filled at the wavelength λ_{E}. In some cases, the ink is not visible in the visible range of electromagnetic energy, but may be detectable in ranges outside of the visible range, such as in the ultraviolet or the infrared ranges of electromagnetic energy. In other cases, the ink may be visible in the visible range at substantially the same color as the entire word mark 202 (e.g., the color that would be visible in the word mark 202 in FIG. 4A), while the ink has the desired spectral response to appear filled at the wavelength λ_{E}.

FIG. 5B depicts the results of the scanning device scanning the substrate 206 at the wavelength λ_{F}. The identification tag 220 has responded in the same manner shown in FIG. 4C with the geometric shapes of the identification tag 220 appearing as filled shapes 240 and unfilled shapes 242. At the wavelength λ_{F}, a binary response of portions of the word mark 202 is detectable. In the depicted embodiment, the word mark 202 has been divided into vertical lanes that appear as either filled lanes 244 or unfilled lanes 246. In the depicted embodiment, the vertical lanes are demarcated by thin, dashed lines for convenience, though such lines may not be marked on the substrate 206 itself. In some embodiments, the portions of the word mark 202 in the filled lanes 244 include an ink that has the desired spectral response to appear filled at the wavelength λ_{F}. In some cases, the ink is not visible in the visible range of electromagnetic energy, but may be detectable in ranges outside of the visible range, such as in the ultraviolet or the infrared ranges of electromagnetic energy. In other cases, the ink may be visible in the visible range at substantially the same color as the entire word mark 202 (e.g., the color that would be visible in the word mark 202 in FIG. 4A), while the ink has the desired spectral response to appear filled at the wavelength λ_{F}.

FIG. 5C depicts the results of the scanning device scanning the substrate 206 at the wavelength λ_{G}. The identification tag 220 has responded in the same manner shown in FIG. 4D with the geometric shapes of the identification tag 220 appearing as filled shapes 250 and unfilled shapes 252. At the wavelength λ_{G}, a binary response of portions of the word mark 202 is detectable. In the depicted embodiment, the word mark 202 has been divided into vertical lanes that appear as either filled lanes 254 or unfilled lanes 256. In the depicted embodiment, the vertical lanes are demarcated by thin, dashed lines for convenience, though such lines may not be marked on the substrate 206 itself. In some embodiments, the portions of the word mark 202 in the filled lanes 254 include an ink that has the desired spectral response to appear filled at the wavelength λ_{G}. In some cases, the ink is not visible in the visible range of electromagnetic energy, but may be detectable in ranges outside of the visible range, such as in the ultraviolet or the infrared ranges of electromagnetic energy. In other cases, the ink may be visible in the visible range at substantially the same color as the entire word mark 202 (e.g., the color that would be visible in the word mark 202 in FIG. 4A), while the ink has the desired spectral response to appear filled at the wavelength λ_{G}.

Information can be encoded into each of the identification tag 220 and the identification tag incorporated into the word mark 202 when scanned at a specific wavelength, such as at the wavelength AE, the wavelength AF, or the wavelength AG. In some embodiments, at least a portion of the information encoded into the identification tag 220 is included in the information encoded into the identification tag incorporated into the word mark 202. For example, the identification tag 220 may include an identifier of the packaging material and the identification tag incorporated into the word mark 202 may include the identifier of the packaging material and a unique serial number associated with a packaged formed from the packaging material. In some embodiments, the information encoded into the identification tag 220 is not included in the information encoded into the identification tag incorporated into the word mark 202. For example, the identification tag 220 may include an identifier of the packaging material and the identification tag incorporated into the word mark 202 may include a link to a website that provides information about proper disposal of the packaging material.

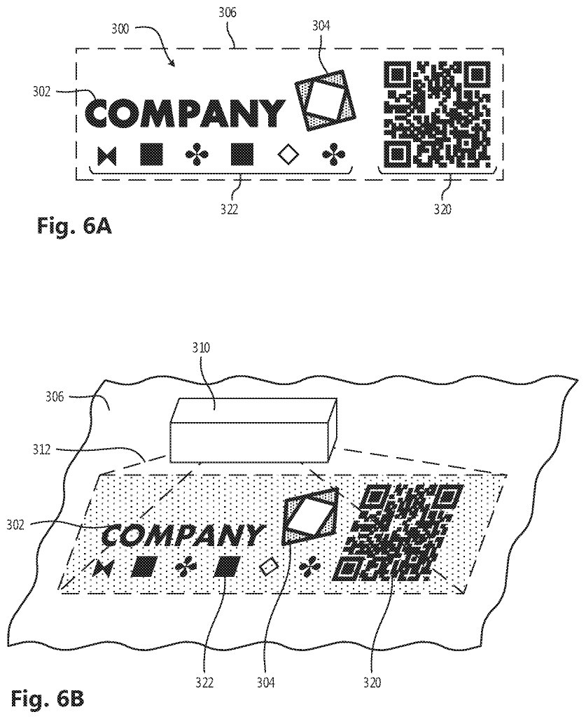

In some of the embodiments described above, identification tags were readable using manners of detection that are based on the wavelength at which the identification tags are scanned. In other embodiments, identification tags can be scanned in using manners of detection that are scanned in the same range of wavelengths. Depicted in FIG. 6A is an example of two identification tags that can be read in the visible spectrum using two different manners of detection.

Depicted in FIG. 6A is an embodiment of a brand mark 300. In the depicted embodiment, the brand mark 300 includes both a word mark 302 and a logo 304. The brand mark 300 is located on a substrate 306. The substrate 306 can be a portion of product packaging that is configured to have a product packaged therein. In the specific embodiment shown in FIG. 6A, no identification tag is incorporated into the brand mark 300. An identification tag 320 and an identification tag 322 are located on the substrate 306 proximate the brand mark 300.

In the depicted embodiment, the identification tag 320 is a QR (quick response) code. QR codes are forms of two-dimensional array codes configured to encode data. In other embodiments, the identification tag 320 may be another form of a two-dimensional code, a one-dimensional code (e.g., a barcode), or any other type of code. QR codes and barcodes are capable of being read by many mobile computing devices (e.g., smart phones) and other devices (e.g., barcode readers) to decode the information encoded therein.

In the depicted embodiment, the identification tag 322 is a symbolic code formed from a number of different symbols. In some embodiments, the symbols that make up the symbolic code are symbols that do not represent alphanumeric characters. An example of a set of symbols that make up a 32-symbol code set are show in Table 1. In the depicted embodiment, the identification tag 322 includes six positions for symbols. With six positions and 32 possible symbols for each position, the identification tag 322 has over one billion possible combinations for encoding information (32⁶ combinations). In other embodiments, a symbolic code can include any number of possible symbols and any number of possible positions for the symbols. In some embodiments, the number of symbols and the number of positions is selected based on a desired number of possible combinations.

One benefit to the use of a symbolic code, such as the symbolic code shown in the identification tag 322, is that a symbolic code may be readable using a computer-based artificial intelligence software. For example, the symbolic code can be read with a combination of a camera system and computing system having an artificial intelligence software configured to identify the symbols that are included in the symbolic code. One example of artificial intelligence software is machine learning models that have models trained from classified data (e.g., images of known symbols) and then classify unclassified data (e.g., images of unknown symbols) using the trained model. In some cases, classification from a trained model is referred to as “deep learning,” which is a subset of machine learning, that generates models based on training data sets provided to it. Additional discussion of training model and using trained models in machine learning are described in U.S. Patent

TABLE 1
Example set of symbolic
characters for encoding information

| | | Unicode |
|---|---|---|
| Ref. | | character |
| no. | Symbol | no. |
| 0 | [symbol] | 2660 |
| 1 | ▾ | 25BC |
| 2 | ∇ | 25BD |
| 3 | ♦ | 25C6 |
| 4 | ⋄ | 25C7 |
| 5 | ● | 25CF |
| 6 | [symbol] | 25D0 |
| 7 | [symbol] | 1F319 |
| 8 | [symbol] | 265C |
| 9 | ★ | 2605 |
| 10 | [symbol] | 2724 |
| 11 | ♥ | 2764 |
| 12 | [symbol] | 274C |
| 13 | ⊙ | 29BF |
| 14 | [symbol] | 29D3 |
| 15 | ▪ | 25A0 |
| 16 | ↔ | 2B0C |
| 17 | [symbol] | 25EA |
| 18 | [symbol] | 25A3 |
| 19 | [symbol] | 25D6 |
| 20 | [symbol] | 2738 |
| 21 | [symbol] | 265A |
| 22 | [symbol] | 265E |
| 23 | [symbol] | 266A |
| 24 | [symbol] | 272A |
| 25 | [symbol] | 273F |
| 26 | [symbol] | 274E |
| 27 | [symbol] | 2388 |
| 28 | [symbol] | 2602 |
| 29 | [symbol] | 2618 |
| 30 | [symbol] | 2663 |
| 31 | ✓ | 2714 |

Applications 62/679,070 and 62/679,072, the contents of each of which are hereby incorporated by reference in their entirety.

In the embodiment shown in FIG. 6B, the substrate 306 is scanned by a scanning device 310. The scanning device 310 is configured to interrogate the substrate 306 and to detect the presence of a readable code on the substrate 306. In the depicted embodiment, the scanning device 310 is configured to interrogate the substrate 306 in a scanning field 312. In some embodiments, the scanning device 310 is configured to read one or more identification tags located on the substrate 306 within the scanning field 312.

It is possible for other codes, such as barcodes and QR codes, to be read by artificial intelligence systems. However, in many circumstances, it may be easier for artificial intelligence systems to accurately read a symbolic code than to read a barcode or a QR code. For example, if the substrate 306 is part of a packaging material formed around a product and the packaged product is in a package handling facility, the packaged product may be moving and/or being handled regularly so that it is difficult to capture a high-resolution image of the identification tags 320 and 322. Because of the nature of a QR code with a large number of small pixels in an array and a seemingly-equal chance of each pixel being filled or unfilled, it may not be possible for an artificial intelligence system to resolve the QR code with the accuracy or confidence level that the proper information is obtained from the QR code. On the other hand, with a limited number of symbols in a set of symbols for a symbolic code and comparatively-small number of symbols in a given code, an artificial intelligence may be much more successful in detecting and accurately identifying the symbolic code. This may allow for large facilities (e.g., packaging facilities, shipping and handling facilities), stores (e.g., cashierless stores), and the like to utilize artificial intelligence systems to scan and identify the identification tag 322 on the substrate 306.

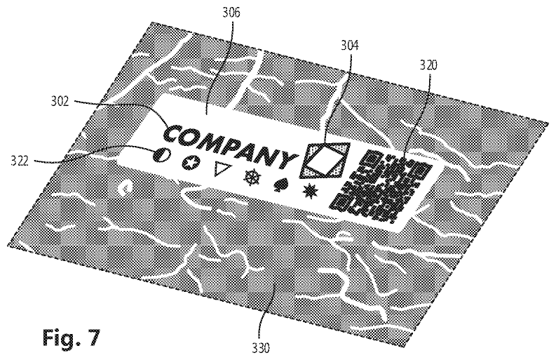

Symbolic codes can also be much more “forgiving” than one- and two-dimensional codes when the appearance of the code is not ideal. During a packaging process, codes on packaging material can be damaged or otherwise deformed, making it more difficult to read the codes. In one example, as shown in FIG. 7, the substrate 306 is shrink film that has been used as packaging material to cover a piece of meat 330 in a shrink package. The identification tags 320 and 322 are printed on the shrink film before the shrink process. During the shrink process, the identification tags 320 and 322 also shrink. Folds, creases, and other artifacts of the shrink process may also be formed in portions of the identification tags 320 and 322, which further reduces the likelihood of a successful scan. Compared to the pixels in an a QR code or the bars in a barcode, the size of the symbols in a symbolic code are relatively large and the number of symbols is relatively few. These characteristics of a symbolic code make the likelihood of a successful scan greater than a barcode or a QR code, particularly if when the scan is done by a camera imaging the identification tags 320 and 322. Moreover, the use of an artificial intelligence system to identify the symbols in a symbolic code can significantly increase the likelihood of accurate identification of symbols that have been deformed or damaged.

While some users may benefit from the presence of the symbolic code in the identification tag 322, other users may not be able to decode the symbolic code in the identification tag 322. For example, a consumer who buys the packaged product with the identification tag 322 likely does not have a tool to decode the symbolic code in the identification tag 322. However, many users likely have the ability to decode a more common form of code, such as a barcode or a QR code, which can be read by many mobile computing devices (e.g., smart phones). In this way, the QR code in the identification tag 320 can be scanned by those users to obtain information about the packaged product (e.g., a unique identifier of the packaged product, an identifier of the product packaged therein, an identifier of the packaging material, and the like). Codes such as barcodes and QR codes may take more time to properly scan and decode and may require more resolute images than are feasible in a packaging or handling facilities. However, customers in retail stores, consumers at their residences, and others are likely to have sufficient time to obtain sufficiently-resolute images to scan and decode the identification tag 320.

In some embodiments, an identification tag of a packaged product may be a set of features about the packaged product that, when taken together, represent a unique identification of the package. For example, in the case of shrink film packaging materials that have been shrunk around various cuts of raw meat, a computing device may be able to determine a set of folds and creases in each of the packaged cuts of meat. These sets of folds and creases may be unique to each packaged cut of meat such that the folds and creases on any particular packaged cut of meat serves as an identification tag for that packaged cut of meat. A computing device downstream in a distribution chain may scan the packages meat product, identify its specific set of fold and creases, and send the set of identified folds and creases as an identification tag for that packaged cut of meat. It will be apparent that any other physical characteristic could be used in a set of identifying features, such as size, shape, weight, minute defects in aesthetic features (e.g., printed material on the packaging material), any other characteristic, or any combination thereof. In some cases, a unique set of features that identifies a packaged product may be referred to as a “signature” or “fingerprint” of that packaged product.

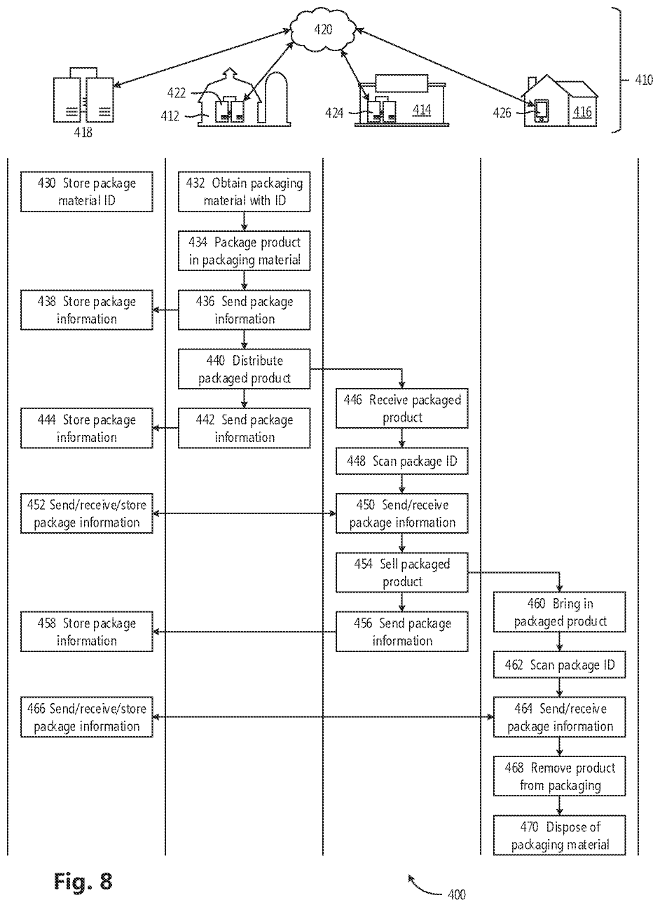

A packaging material that has two identification tags, which are readable using different manners of detection, can increase the likelihood of the packaged product being scanned and identified from the start of the chain of distribution until the disposal of the packaging material. One of the identification tags can be scannable by sophisticated systems (e.g., artificial intelligence systems that can obtain images with multiple packages at the same time) and the other can be scanned by less sophisticated systems (e.g., smart phones with cameras that obtain images of individual codes). In this way, the package is scannable regardless of the point it is in from the start of the chain of distribution until the disposal of the packaging material. An embodiment of how a packaging material and a packaged product can be identified throughout its lifecycle is depicted in FIG. 8.

FIG. 8 depicts an embodiment of a method 400 that can be performed in a distribution chain 410. The distribution chain 410 includes a packaging facility 412, a retail store 414, and a consumer residence 416. It will be appreciated that the distribution chain 410 can include other facilities, such as a manufacturing plant of the packaging material, a processing facility of the product, a distribution warehouse between the packaging facility 412 and the retail store 414, transportation vehicles, and the like. In the depicted embodiment, the packaging facility 412 has been outlined as a farm, such as in the case of a food product. However, it will be apparent that the product can also be any a non-food product.

As depicted in FIG. 8, the distribution chain 410 can also include a computing system 418. The computing system 418 can include one or more computing devices, such as servers, that are capable of storing and processing information. In some embodiments, the computing system 418 is located in a data center or other computing device housing facility. In some embodiments, the computing system 418 is operated by or on behalf of a manufacturer of the packaging material to track the packaging material and/or the packaged product through their lifecycles. The computing system 418 is communicatively coupled to a network 420. The network 420 may include any number of wired and/or wireless networks, such as the internet, local area networks, cellular telephone networks, WiFi networks, and the like. The network 420 is communicatively coupled to each of a computing system 422 at the packaging facility 412, a computing system 424 and the retail store 414, and to a computing system 426 and the consumer residence 416. Each of the computing systems 422, 424, and 426 may include one or more computing devices, such as a server, a desktop computer, a laptop computer, a tablet computing device, a mobile telephone, and the like. Each of the computing systems 418, 422, 424, and 426 is capable of communicating information to and from each of the other computing systems 418, 422, 424, and 426 via the network 420. It will be noted that the computing systems 422, 424, and 426 are typically located remotely from the computing system 418, but some or all of the computing systems 422, 424, and 426 could be located locally with the computing system 418.

In the embodiment of the method 400 depicted in FIG. 8, the computing system 418 stores an identifier associated with packaging material at block 430. In some embodiments, the identifier includes at least one of an identifier of the type of the packaging material, a unique identifier of a package that can be formed by the packaging material, a manufacturer of the packaging material, or any other identifier associated with the packaging material. In some embodiments, a manufacturer of the packaging material provides the identifier to the computing system 418 for storage at block 430. In some embodiments, the computing system 418 is configured to store the identifier in a specific data structure, such as a lookup table, a two-dimensional database, a blockchain structure, and the like. In some embodiments where the lifecycle of a specific product or package is to be tracked, data structures such as blockchain structures are convenient to ensure the propriety of the data over the lifecycle of the packaging material and/or the packaged product. At block 430, the computing system 418 may also store information about the packaging material, such as one or more types of material that are included in the packaging material.

At block 432, the packaging facility 412 obtains the packaging material that includes the identifier. For example, the packaging facility 412 may purchase the packaging material from a manufacturer of the packaging material. In some embodiments, the identifier is encoded into an identification tag located on the packaging material. In some embodiments, the identifier is encoded into two identification tags located on the packaging material, where the two identification tags are machine readable using different manners of detection. At block 434, a product is packaged into the packaging material. For example, a food product is placed into the packaging material and the packaging material is sealed around the food product.

At block 436, the computing system 422 at the packaging facility 412 sends package information to the computing system 418. In the depicted embodiment, the computing system 422 sends package information to the computing system 418 via the network 420. In some embodiments, the identifier is scanned from an identification tag on the packaging material and included with the package information sent to the computing system 418. For example, a camera may take an image of the package and machine learning software operating on the computing system 422 may identify the code (e.g., symbols in a symbolic code) and decode the code to obtain the identifier. The package information sent to the computing system 418 may also include other information or characteristics about the packaged product, such as the date of packaging, the product in the package, ingredients in the product, physical characteristics of the packaged product (e.g., weight, dimensions, etc.), preparation instructions for the product, or any other such information. At block 438, the computing system 418 stores the package information received from the computing system 422. In some embodiments, the computing system 418 stores the package information in the same data structure as the identifier was stored. For example, when the data structure is blockchain, the package information can be stored in another block in the chain associated with the identifier.

At block 440, the packaging facility 412 distributes the packaged product. In some embodiments, distributing the packaged product includes one or more of shipping the packaged product, transporting the packaged product, wholesaling the packaged product, inventorying the packaged product, and the like. In the depicted embodiment, distributing the packaged product includes handling the packaged product such that the packaged product reaches the retail store 414. At block 442, the computing system 422 sends packaging information to the computing system 418. In some embodiments, the packaging information sent at block 442 can include information about the distribution of the packaged product (e.g., a shipping tracking number, a distribution carrier, a date on which the packaged product left the packaging facility 412, etc.). The sending of the package information at block 442 can be done in response to scanning an identification tag on the packaging material at the time that the packaged product was distributed (sometimes called a “departure scan”). At block 444, the computing system 418 stores the package information received from the computing system 422. In some embodiments, the computing system 418 stores the package information in the same data structure as the identifier and previously-received packaging information were stored. For example, when the data structure is blockchain, the package information can be stored in another block in the chain associated with the identifier.

At block 446, the retail store 414 receives the packaged product. Upon receipt of the packaged product, the retail store 414 can, at block 448, scan the identifier from the identification tag of the packaging material of the packaged product (sometimes called an “arrival scan”). In some embodiments, the scan of the identifier by the retail store 414 can be done using a manner of detection that is the same as was done by the packaging facility 412, such as taking an image of the identification tag and processing the image using a machine learning trained model. In other embodiments, the scan of the identifier by the retail store 414 can be done using a different manner of detection than was done by the packaging facility 412, such as scanning another code, such as a barcode or a QR code, using a barcode scanner, a mobile computing device, or any other type of scanning device.

At block 450, the computing system 424 at the retail store 414 sends package information to the computing system 418. In the depicted embodiment, the computing system 424 sends package information to the computing system 418 via the network 420. The package information sent to the computing system 418 may include the identifier and also include other information, such as the date that the packaged product arrived at the retail store 414, a location of the retail store 414, or any other information about the packaged product. At block 452, the computing system 418 stores the package information received from the computing system 424. In some embodiments, the computing system 418 stores the package information in the same data structure as the identifier and previously-received packaging information were stored. For example, when the data structure is blockchain, the package information can be stored in another block in the chain associated with the identifier. At block 452, the computing system 418 can also send information back to the computing system 424 about the product, including any information previously stored about the packaged product, any information associated with the packaging material of the packaged product, and the like.

At block 454, the retail store 414 sells the packaged product. In some embodiments, the packaged product is sold to a consumer. At block 456, the computing system 422 sends packaging information to the computing system 418. In some embodiments, the packaging information sent at block 456 can include information about the sale of the packaged product (e.g., a sale date, a sale price, etc.). The sending of the package information at block 456 can be done in response to scanning an identification tag on the packaging material at the time of the sale. For example, the identification tag can be scanned at a point-of-sale terminal (e.g., a cashier's station, a self-serve checkout, an exit point of a cashierless store, etc.). At block 458, the computing system 418 stores the package information received from the computing system 424. In some embodiments, the computing system 418 stores the package information in the same data structure as the identifier and previously-received packaging information were stored. For example, when the data structure is blockchain, the package information can be stored in another block in the chain associated with the identifier.

At block 460, the packaged product is brought in to the consumer residence 416. At block 462, the consumer can scan the identifier from the identification tag of the packaging material of the packaged product. While the scanning of the product at block 462 is depicted at the consumer residence 416 in FIG. 8, it will be understood that the consumer can scan an identification tag on the packaged product at any other location (e.g., in the retail store 414 before purchase, at a location other than the retail store 414 or the consumer residence 416, etc.). In some embodiments, the scan of the identifier by the consumer can be done using a different manner of detection than was done by the packaging facility 412 or the retail store 414. For example, the computing system 426 may be a mobile computing device (e.g., a smart phone) that can scan a barcode or a QR code on the product packaging.

At block 464, the computing system 426 sends package information to the computing system 418. In the depicted embodiment, the computing system 426 sends package information to the computing system 418 via the network 420. The package information sent to the computing system 418 may include the identifier and also include other information, such as the date that the packaged product was brought into the consumer residence 416, a condition of the product and/or the packaging when the packaged product was brought into the consumer residence 416, or any other information about the packaged product. At block 466, the computing system 418 stores the package information received from the computing system 426. In some embodiments, the computing system 418 stores the package information in the same data structure as the identifier and previously-received packaging information were stored. For example, when the data structure is blockchain, the package information can be stored in another block in the chain associated with the identifier.

At block 466, the computing system 418 can also send information back to the computing system 426 about the product, including any information previously stored about the packaged product, any information associated with the packaging material of the packaged product, and the like. For example, the computing system 418 can send, to the computing system 426, information about the product inside the package, information about how to properly dispose of the packaging material, and the like. In another example, the computing system 418 can send information to enhance the experience of the consumer, such as augmented reality information that can be displayed by the computing system 426 (e.g., displayed over an image or live video of the packaged product), video information that can be displayed by the computing system 426 (e.g., a video about the packaged product), sound information that can be played by the computing device (e.g., a spoken description of the packaged product), and the like.

At block 468, the consumer can remove the product from the packaging material. For example, in the case of a food product, the consumer can remove the product to eat the product or prepare the food product for consumption. In the case of non-food products, the consumer can remove the product from the packaging material to be able to use the product. After the packaging material is no longer needed, the consumer can, at block 470, dispose of the packaging material. In some embodiments, the information received by the computing system 426 from the computing system 418 may include information about proper disposal of the packaging material. For example, the information received by the computing system 426 from the computing system 418 may include information about recycling the packaging material. In some cases, the manufacturer of the packaging material provided the computing system 418 with the type(s) of materials in the packaging material and the computing system 418, in response to receiving the specific identifier for that packaging material from the computing system 426, provides specific instructions for recycling the type(s) of material in the packaging material. In this way, the consumer does not have to figure out and/or guess what type(s) of material are in the packaging material when deciding how to recycle the packaging material.

Looking back at the entire method 400 and the distribution chain 410, it is apparent that information about the lifecycle of packaging material can be tracked and identified throughout the entire lifecycle and distribution chain 410. During any point of the method 400, a computing device can scan an identifier on the packaging material and submit a query to the computing system 418 to obtain information about past events in the lifecycle and/or expected future events in the lifecycle. In the case of a food product, examples of past events include growing or raising of the food product, a harvesting of the food product, a processing of the food product, a manufacturing of the packaging material, a packaging of the food product inside the packaging material, a maximum storage temperature of the food product, a recall of the food product, any other past event, or any combination thereof. In the case of a food product, examples of expected future events include a sell-by date associated with the food product, a use-by date associated with the food product, a step to prepare the food product for consumption, a step to prepare the packaging material for recycling, any other expected future event, or any combination thereof.

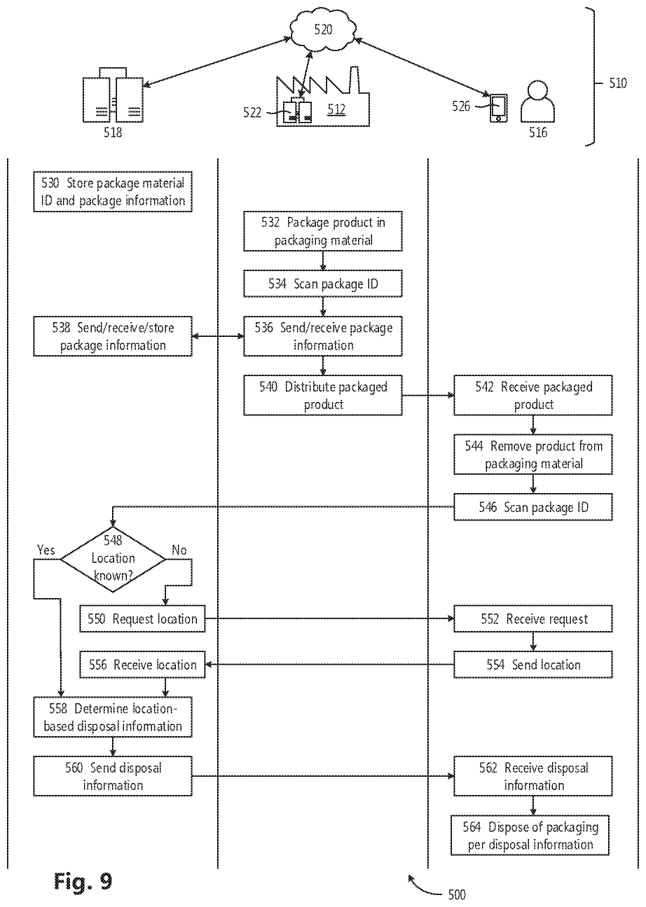

As noted above, an identification tag on packaging material can allow a user to scan the identification tag to obtain information about the packaging material. In some cases, that information may include the type of packaging material. Knowing the packaging material may aid the user in determined how to dispose of the packaging material, such as how to properly recycle the material. For example, when a user's computing device (e.g., computing system 426) scans an identification tag on packaging material, the user's computing device can send a communication to a remote computing system (e.g., computing system 418) to obtain information about the packaging material. In some embodiments, the remote computing device can determine a location associated with the user's computing device and location-based disposal information that includes a disposal method for the specific type of packaging material in the determined location (e.g., a method of properly recycling the packaging material in the user's location). This location-based disposal information can be sent to the user's computing device to aid the user in properly disposing of the packaging material. An embodiment of providing location-based disposal information to a user's computing device is depicted in FIG. 9.

FIG. 9 depicts an embodiment of a method 500 that can be performed in a distribution chain 510. The distribution chain includes a packaging facility 512 and a user 516. It will be appreciated that the distribution chain 510 can include other facilities, such as a manufacturing plant of the packaging material, a processing facility of the product, a distribution warehouse, a retail store, transportation vehicles, and the like. In the depicted embodiment, the packaging facility 512 has been outlined as a manufacturing facility, such as in the case of a non-food product. However, it will be apparent that the product can also a food product.

As depicted in FIG. 9, the distribution chain 510 can also include a computing system 518. The computing system 518 can include one or more computing devices, such as servers, that are capable of storing and processing information. In some embodiments, the computing system 518 is located in a data center or other computing device housing facility. In some embodiments, the computing system 518 is operated by or on behalf of a manufacturer of the packaging material to track the packaging material and/or the packaged product through their lifecycles. The computing system 518 is communicatively coupled to a network 520. The network 520 may include any number of wired and/or wireless networks, such as the internet, local area networks, cellular telephone networks, WiFi networks, and the like. The network 520 is communicatively coupled to each of a computing system 522 at the packaging facility 512 and a computing system 526 with the user 516. Each of the computing systems 522 and 526 may include one or more computing devices, such as a server, a desktop computer, a laptop computer, a tablet computing device, a mobile telephone, and the like. Each of the computing systems 518, 522, and 526 is capable of communicating information to and from each of the other computing systems 518, 522, and 526 via the network 520. It will be noted that the computing systems 522 and 526 are typically located remotely from the computing system 518, but some or all of the computing systems 522 and 526 could be located locally with the computing system 518.

In the embodiment of the method 500 depicted in FIG. 9, the computing system 518 stores an identifier associated with packaging material at block 530. In some embodiments, the identifier includes at least one of an identifier of the type of the packaging material, a unique identifier of a package that can be formed by the packaging material, a manufacturer of the packaging material, or any other identifier associated with the packaging material. In some embodiments, a manufacturer of the packaging material provides the identifier to the computing system 518 for storage at block 530. In some embodiments, the computing system 518 is configured to store the identifier in a specific data structure, such as a lookup table, a two-dimensional database, a blockchain structure, and the like. In some embodiments where the lifecycle of a specific product or package is to be tracked, data structures such as blockchain structures are convenient to ensure the propriety of the data over the lifecycle of the packaging material and/or the packaged product. At block 530, the computing system 518 may also store information about the packaging material, such as one or more types of material that are included in the packaging material.

At block 532, the packaging facility 512 a product is packaged into the packaging material. For example, a non-food product is placed into the packaging material and the packaging material is closed around the non-food product. The computing system 522 at the packaging facility 512 can store package information about the packaged product in connection with an identifier encoded into an identification tag on the packaging material. At block 534, the computing system 522 scans an identifier of the packaged product. In some embodiments, the identifier can be scanned from an identification tag on the packaging material. For example, a camera may take an image of the package and machine learning software operating on the computing system 522 may identify the code (e.g., symbols in a symbolic code) and decode the code to obtain the identifier. The package information may also include other information or characteristics about the packaged product, such as the date of packaging, the product in the package, physical characteristics of the packaged product (e.g., weight, dimensions, etc.), usage instructions for the product, or any other such information.

At block 536, the computing system 522 at the packaging facility 512 sends package information to the computing system 518. In the depicted embodiment, the computing system 522 sends the package information to the computing system 518 via the network 520. In some embodiments, the identifier is scanned from an identification tag on the packaging material and included with the package information sent to the computing system 518. In some embodiments, the packaging information sent at block 536 can include information about a planned distribution of the packaged product (e.g., a shipping tracking number, a distribution carrier, a planned date on which the packaged product will leave the packaging facility 512, etc.). The sending of the package information at block 442 can be done in response to the scanning, at block 534, of the identification tag on the packaging material at the time that the packaged product was distributed (sometimes called a “departure scan”). At block 538, the computing system 518 stores the package information received from the computing system 522. In some embodiments, the computing system 518 stores the package information in the same data structure as the identifier and previously-received packaging information were stored. For example, when the data structure is blockchain, the package information can be stored in another block in the chain associated with the identifier. At block 538, the computing system 518 can also send information back to the computing system 522 about the packaged product, including any information previously stored about the packaged product, any information associated with the packaging material of the packaged product, and the like.

At block 540, the packaging facility 512 distributes the packaged product. In some embodiments, distributing the packaged product includes one or more of shipping the packaged product, transporting the packaged product, wholesaling the packaged product, inventorying the packaged product, and the like. In the depicted embodiment, the packaging facility 512 ships the packaged product directly to the user 516. This may be the case with e-commerce shipping facilities, meal-kit delivery preparation facilities, and the like. In other embodiments, the packaging facility 512 may send the packaged product to another location (e.g., a retail store) before the user 516 receives the packaged product.

At block 542, the user 516 receives the packaged product. At block 544, the user 516 can remove the product from the packaging material, such as to use the product. At block 546, the consumer can scan the identifier from the identification tag of the packaging material of the packaged product. In some embodiments, the scan of the identifier by the user 516 at block 546 can be done using a different manner of detection than was done by the packaging facility 512. For example, the computing system 526 may be a mobile computing device (e.g., a smart phone) that can scan a barcode or a QR code on the product packaging. In some embodiments, the scanning of the package identifier by the computing system 526 at block 546 may cause the computing system 526 to send a communication to the computing system 518 that includes an indication of the packaging identifier.

At block 548, the computing system 518 may determine whether a location associated with the computing system 526 is known. The location associated with the computing system 526 can be determined in a number of ways. In some embodiments, when the computing system 526 sends the communication to the computing system 518 after the scanning at block 546, the computing system 526 can include an indication of the location associated with the computing system 526 in the communication. For example, the computing system 526 can include a location module, such as a global positioning system (GPS) module, configured to determine a location of the computing system 526 and the computing system 526 includes a location determined by the location module in the communication. In some embodiments, the computing system 526 is configured to receive a user input indicative of the location (e.g., a user-inputted zip code or postal code) and the computing system 526 includes the user-inputted location in the communication. In some embodiments, the computing system 518 is configured to determine a location associated with the computing system 526 based on the communication from the computing system 526. For example, the computing system 518 may determine a location based on an internet protocol (IP) address from which the communication was sent by the computing system 526. In some embodiments, the computing system 518 may have information about the distribution of the packaged product. In one example, the computing system 518 may have received a shipping destination (e.g., a destination zip code or postal code) from the computing system 522 at block 538 and the computing system 518 may use the shipping destination as the location associated with the computing system 526. In other examples, the computing system 518 may have other information about the distribution of the packaged product from the distribution chain 510, such as a location of a retail store that sold the packaged product to a customer, a region of intended retail sale of the packaged product, or any other information obtained about the distribution of the packaged product.

If, at block 548, the computing system 518 determines that a location associated with the computing system 526 is not known, then, at block 550, the computing system 518 sends a request to the computing system 526 for a location. At block 552, the computing system 526 receives the request for the location. In some embodiments, the computing system 526 may be configured to automatically determine the location in response to receiving the request, such as by using a location module in the computing system 526 to determine the location. In other embodiments, the computing system 526 may be configured to prompt the user 516 to enter a location. At block 554, the computing system 526 sends the location to the computing system 518. At block 556, the computing system 518 receives the location from the computing system 526. From there, the method 500 proceeds to block 558. However, if, at block 548, the computing system 518 determines that a location associated with the computing system 526 is known, then the method 500 proceeds to block 558.

At block 558, the computing system 518 determines location-based disposal information for the packaging material. In some embodiments, determining the location-based disposal information includes identifying a material type of the packaging material. For example, the computing system 518 can determine the specific information by looking up the material type associated with the package identifier form the information stored at block 530. In the case where the manufacturer of the packaging material provided the information to be stored at block 530, the computing system 518 is obtaining the material type specified by the manufacturer when determining the material type associated with the identifier sent by the computing system 526 at block 546. In some embodiments, determining the location-based disposal information includes determining a disposal method for the material type of the material in the location. For example, the method can include placing the packaging material in a curbside recycling container that is collected and recycled by a municipal service in that location, placing the packaging material in a landfill trash container, placing the packaging material in a compost bin, and the like. In some embodiments, determining the location-based disposal information includes determining a disposal facility associated with the location, such as a retail store that collects that material type for recycling, a commercial recycling facility that collects that material type for recycling, a waste facility that accepts that material type, and the like.

At block 560, the computing system 518 sends the location-based disposal information to the computing system 526. At block 562, the computing system 526 location-based disposal information. In response to receiving the location-based disposal information, the computing system 526 may notify the user 516 of the location-based disposal information, such as by displaying the location-based disposal information. At block 564, the user 516 can dispose of the packaging material according to the location-based disposal information. In some embodiments, when the computing system 518 both identifies the location associated with the computing system 526 automatically and determines the material type of the packaging material from the information stored at block 530 to determine the location-based disposal information, the burden on the user 516 to determine how to properly dispose of the packaging material is significantly reduced. In addition, the possibility of user error when disposing of the packaging material at block 564 is also greatly reduced because the location-based disposal information can be specific to the disposal methods available to the user 516 at the user's location. Also, this system also allows for location-based disposal information to be updated dynamically as disposal methods change for specific locations and/or types of materials. For example, if the disposal method changes for a specific type of packaging material in a specific location (e.g., that packaging material can now be placed in curbside recycling cans instead of taken to a commercial facility), the disposal information stored on the computing system 518 for recycling that packaging material in that location can be updated. Subsequently, if a user scans a package identifier (e.g., the user 516 scans the package identifier at block 546), the new location-based disposal information will be obtained from the computing system 518 (e.g., at block 558) and the new location-based disposal information can be provided to the user (e.g., at block 560). This ensures that the user will obtain current disposal information without having to proactively keep up-to-date about all types of proper packaging material disposal.

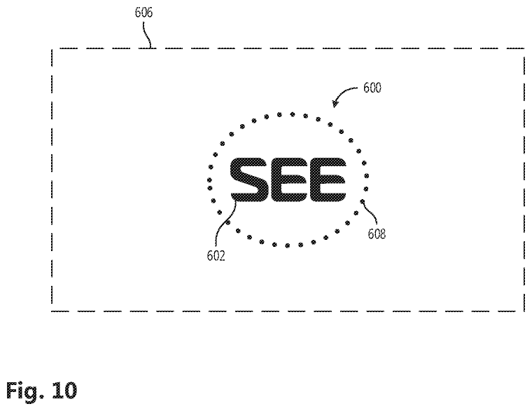

In some of the embodiments described above, brand marks on substrates have identification tags that are either incorporated into the brand mark itself or are in proximity to the brand mark. In some embodiments, the aspects that are machine-readable are not visible to a user when viewing the brand mark, such as in the case of the barcode 120 that is readable outside of the visible range in FIG. 3A or in the case of the filled lanes 130, 140, and 150 and the unfilled lanes 132, 142, and 152 shown in FIGS. 3B-3D. In the case where the identification tag is not visible, it may be difficult for a user to know where to scan the packaging material so that the identification tag is read. Depicted in FIG. 10 is an embodiment of a brand mark that has a scan indicator to aid the user in identifying an area to scan.

Depicted in FIG. 10 is an embodiment of a brand mark 600. In the depicted embodiment, the brand mark 600 includes both a word mark 602 and a scan indicator 608. In other embodiments, the brand mark 600 may include the word mark 602, a logo, a particular color, a design, a picture, a symbol, a particular font or typeface, any other indicia of the owner of the brand, or any combination thereof. In the depicted embodiment, the word mark includes one instance of the character “S” and two instances of the character “E”. In other embodiments, the word mark 602 may have different characters, such as letters (e.g., “A”, “B”, or “C”), numbers (e.g., “1”, “2”, or “3”), and the like. In the depicted embodiment, the brand mark 600 is located on a substrate 606. The substrate 606 can be a portion of product packaging that is configured to have a product packaged therein.

As shown in FIG. 10, a scan indicator 608 is located on the substrate 606 in proximity to the word mark 602. In the depicted embodiment, the scan indicator 608 is a dotted oval that circumscribes the word mark 602. In other embodiments, the scan indicator 608 can be any other marking or indication of an area of the substrate 606 that can be scanned. In the depicted embodiment, a non-visible identification tag can be located anywhere within the scan indicator. In one example, the identification tag can be incorporated into the word mark 602, similar to the way in which the filled lanes 130, 140, and 150 and the unfilled lanes 132, 142, and 152 are incorporated into the word mark 102 in FIGS. 3B-3D. In another example, the identification tag can be a non-visible, one- or two-dimensional code located either “behind” the word mark 602 (i.e., so that the word mark overlaps the code) or between the word mark 602 and the scan indicator 608. In embodiments where the identification tag is within the scan indicator 608, a user can orient a scanning device so that the scanning device scans the entirety of the scan indicator 608 to ensure that the non-visible identification tag is read. It will be noted that any of the brand marks and/or identification tags described herein can have scan indicators positioned in proximity to indicate an area to be scanned.

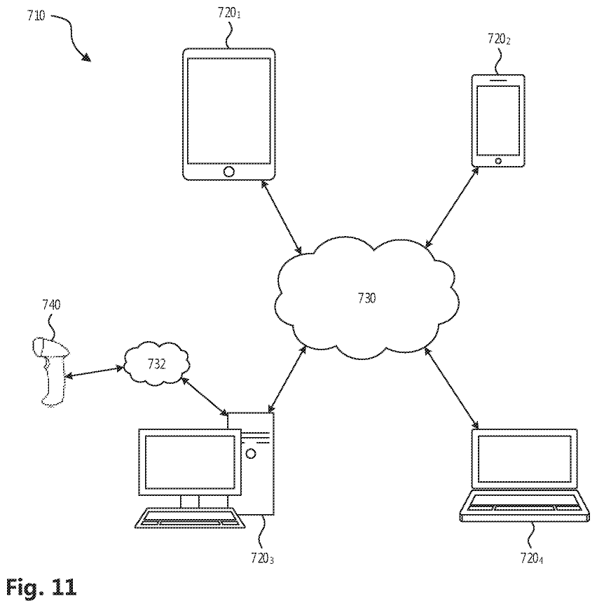

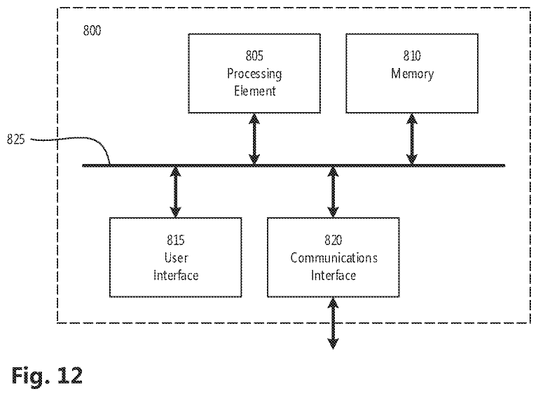

FIG. 11 depicts an example embodiment of a system 710 that may be used to implement some or all of the embodiments described herein. In the depicted embodiment, the system 710 includes computing devices 720₁, 720₂, 720₃, and 720₄ (collectively computing devices 720). In the depicted embodiment, the computing device 720₁ is a tablet, the computing device 720₂ is a mobile phone, the computing device 720₃ is a desktop computer, and the computing device 720₄ is a laptop computer. In other embodiments, the computing devices 720 include one or more of a desktop computer, a mobile phone, a tablet, a phablet, a notebook computer, a laptop computer, a distributed system, a gaming console (e.g., Xbox, Play Station, Wii), a watch, a pair of glasses, a key fob, a radio frequency identification (RFID) tag, an ear piece, a scanner, a television, a dongle, a camera, a wristband, a wearable item, a kiosk, an input terminal, a server, a server network, a blade, a gateway, a switch, a processing device, a processing entity, a set-top box, a relay, a router, a network access point, a base station, any other device configured to perform the functions, operations, and/or processes described herein, or any combination thereof.

The computing devices 720 are communicatively coupled to each other via one or more networks 730 and 732. Each of the networks 730 and 732 may include one or more wired or wireless networks (e.g., a 3G network, the Internet, an internal network, a proprietary network, a secured network). The computing devices 720 are capable of communicating with each other and/or any other computing devices via one or more wired or wireless networks. While the particular system 710 in FIG. 11 depicts that the computing devices 720 communicatively coupled via the network 730 include four computing devices, any number of computing devices may be communicatively coupled via the network 730.

In the depicted embodiment, the computing device 720₃ is communicatively coupled with a peripheral device 740 via the network 732. In the depicted embodiment, the peripheral device 740 is a scanner, such as a barcode scanner, an optical scanner, a computer vision device, and the like. In some embodiments, the network 732 is a wired network (e.g., a direct wired connection between the peripheral device 740 and the computing device 720₃), a wireless network (e.g., a Bluetooth connection or a WiFi connection), or a combination of wired and wireless networks (e.g., a Bluetooth connection between the peripheral device 740 and a cradle of the peripheral device 740 and a wired connection between the peripheral device 740 and the computing device 720₃). In some embodiments, the peripheral device 740 is itself a computing device (sometimes called a “smart” device). In other embodiments, the peripheral device 740 is not a computing device (sometimes called a “dumb” device).

Depicted in FIG. 12 is a block diagram of an embodiment of a computing device 800. Any of the computing devices 720 and/or any other computing device described herein may include some or all of the components and features of the computing device 800. In some embodiments, the computing device 800 is one or more of a desktop computer, a mobile phone, a tablet, a phablet, a notebook computer, a laptop computer, a distributed system, a gaming console (e.g., an Xbox, a Play Station, a Wii), a watch, a pair of glasses, a key fob, a radio frequency identification (RFID) tag, an ear piece, a scanner, a television, a dongle, a camera, a wristband, a wearable item, a kiosk, an input terminal, a server, a server network, a blade, a gateway, a switch, a processing device, a processing entity, a set-top box, a relay, a router, a network access point, a base station, any other device configured to perform the functions, operations, and/or processes described herein, or any combination thereof. Such functions, operations, and/or processes may include, for example, transmitting, receiving, operating on, processing, displaying, storing, determining, creating/generating, monitoring, evaluating, comparing, and/or similar terms used herein. In one embodiment, these functions, operations, and/or processes can be performed on data, content, information, and/or similar terms used herein.

In the depicted embodiment, the computing device 800 includes a processing element 805, memory 810, a user interface 815, and a communications interface 820. The processing element 805, memory 810, a user interface 815, and a communications interface 820 are capable of communicating via a communication bus 825 by reading data from and/or writing data to the communication bus 825. The computing device 800 may include other components that are capable of communicating via the communication bus 825. In other embodiments, the computing device does not include the communication bus 825 and the components of the computing device 800 are capable of communicating with each other in some other way.

The processing element 805 (also referred to as one or more processors, processing circuitry, and/or similar terms used herein) is capable of performing operations on some external data source. For example, the processing element may perform operations on data in the memory 810, data receives via the user interface 815, and/or data received via the communications interface 820. As will be understood, the processing element 805 may be embodied in a number of different ways. In some embodiments, the processing element 805 includes one or more complex programmable logic devices (CPLDs), microprocessors, multi-core processors, co processing entities, application-specific instruction-set processors (ASIPs), microcontrollers, controllers, integrated circuits, application specific integrated circuits (ASICs), field programmable gate arrays (FPGAs), programmable logic arrays (PLAs), hardware accelerators, any other circuitry, or any combination thereof. The term circuitry may refer to an entirely hardware embodiment or a combination of hardware and computer program products. In some embodiments, the processing element 805 is configured for a particular use or configured to execute instructions stored in volatile or nonvolatile media or otherwise accessible to the processing element 805. As such, whether configured by hardware or computer program products, or by a combination thereof, the processing element 805 may be capable of performing steps or operations when configured accordingly.

The memory 810 in the computing device 800 is configured to store data, computer-executable instructions, and/or any other information. In some embodiments, the memory 810 includes volatile memory (also referred to as volatile storage, volatile media, volatile memory circuitry, and the like), non-volatile memory (also referred to as non-volatile storage, non-volatile media, non-volatile memory circuitry, and the like), or some combination thereof.

In some embodiments, volatile memory includes one or more of random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, any other memory that requires power to store information, or any combination thereof.

In some embodiments, non-volatile memory includes one or more of hard disks, floppy disks, flexible disks, solid-state storage (SSS) (e.g., a solid state drive (SSD)), solid state cards (SSC), solid state modules (SSM), enterprise flash drives, magnetic tapes, any other non-transitory magnetic media, compact disc read only memory (CD ROM), compact disc-rewritable (CD-RW), digital versatile disc (DVD), Blu-ray disc (BD), any other non-transitory optical media, read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, Memory Sticks, conductive-bridging random access memory (CBRAM), phase-change random access memory (PRAM), ferroelectric random-access memory (FeRAM), non-volatile random access memory (NVRAM), magneto-resistive random access memory (MRAM), resistive random-access memory (RRAM), Silicon Oxide-Nitride-Oxide-Silicon memory (SONOS), floating junction gate random access memory (FJG RAM), Millipede memory, racetrack memory, any other memory that does not require power to store information, or any combination thereof.

In some embodiments, memory 810 is capable of storing one or more of databases, database instances, database management systems, data, applications, programs, program modules, scripts, source code, object code, byte code, compiled code, interpreted code, machine code, executable instructions, or any other information. The term database, database instance, database management system, and/or similar terms used herein may refer to a collection of records or data that is stored in a computer-readable storage medium using one or more database models, such as a hierarchical database model, network model, relational model, entity relationship model, object model, document model, semantic model, graph model, or any other model.

The user interface 815 of the computing device 800 is in communication with one or more input or output devices that are capable of receiving inputs into and/or outputting any outputs from the computing device 800. Embodiments of input devices include a keyboard, a mouse, a touchscreen display, a touch sensitive pad, a motion input device, movement input device, an audio input, a pointing device input, a joystick input, a keypad input, peripheral device 740, foot switch, and the like. Embodiments of output devices include an audio output device, a video output, a display device, a motion output device, a movement output device, a printing device, and the like. In some embodiments, the user interface 815 includes hardware that is configured to communicate with one or more input devices and/or output devices via wired and/or wireless connections.

The communications interface 820 is capable of communicating with various computing devices and/or networks. In some embodiments, the communications interface 820 is capable of communicating data, content, and/or any other information, that can be transmitted, received, operated on, processed, displayed, stored, and the like. Communication via the communications interface 820 may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, communication via the communications interface 820 may be executed using a wireless data transmission protocol, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (WiFi), WiFi Direct, 802.16 (WiMAX), ultra wideband (UWB), infrared (IR) protocols, near field communication (NFC) protocols, Wibree, Bluetooth protocols, wireless universal serial bus (USB) protocols, or any other wireless protocol.

As will be appreciated by those skilled in the art, one or more components of the computing device 800 may be located remotely from other components of the computing device 800 components, such as in a distributed system. Furthermore, one or more of the components may be combined and additional components performing functions described herein may be included in the computing device 800. Thus, the computing device 800 can be adapted to accommodate a variety of needs and circumstances. The depicted and described architectures and descriptions are provided for exemplary purposes only and are not limiting to the various embodiments described herein.

Embodiments described herein may be implemented in various ways, including as computer program products that comprise articles of manufacture. A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

As should be appreciated, various embodiments of the embodiments described herein may also be implemented as methods, apparatus, systems, computing devices, and the like. As such, embodiments described herein may take the form of an apparatus, system, computing device, and the like executing instructions stored on a computer readable storage medium to perform certain steps or operations. Thus, embodiments described herein may be implemented entirely in hardware, entirely in a computer program product, or in an embodiment that comprises combination of computer program products and hardware performing certain steps or operations.

Embodiments described herein may be made with reference to block diagrams and flowchart illustrations. Thus, it should be understood that blocks of a block diagram and flowchart illustrations may be implemented in the form of a computer program product, in an entirely hardware embodiment, in a combination of hardware and computer program products, or in apparatus, systems, computing devices, and the like carrying out instructions, operations, or steps. Such instructions, operations, or steps may be stored on a computer readable storage medium for execution buy a processing element in a computing device. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments can produce specifically configured machines performing the steps or operations specified in the block diagrams and flowchart illustrations. Accordingly, the block diagrams and flowchart illustrations support various combinations of embodiments for performing the specified instructions, operations, or steps.

For purposes of this disclosure, terminology such as “upper,” “lower,” “vertical,” “horizontal,” “inwardly,” “outwardly,” “inner,” “outer,” “front,” “rear,” and the like, should be construed as descriptive and not limiting the scope of the claimed subject matter. Further, the use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Unless stated otherwise, the terms “substantially,” “approximately,” and the like are used to mean within 5% of a target value.

The principles, representative embodiments, and modes of operation of the present disclosure have been described in the foregoing description. However, aspects of the present disclosure which are intended to be protected are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure, as claimed.

1. A method of facilitating disposal of packaging material, the method comprising:
providing a packaging material configured to have a product packaged therein, wherein the packaging material includes an identification tag that includes an identifier, and wherein the identifier is readable regardless of whether the product is packaged in the packaging material or has been removed from the packaging material;
receiving, by one or more computing devices from a remote computing device, a communication that includes the identifier read by the remote computing device from the identification tag of the packaging material;
identifying, by the one or more computing devices, a location associated with the remote computing device;
determining, by the one or more computing devices, location-based disposal information for the packaging material that is based at least in part on the location associated with the remote computing device; and
sending, from the one or more computing devices to the remote computing device, an indication of the location-based disposal information for the packaging material.

2. The method of claim 1, wherein the communication received by the one or more computing devices from the remote computing device includes an indication of the location associated with the remote computing device.

3. The method of claim 2, wherein the remote computing device includes a location module and the remote computing device is configured to include the indication of the location in the communication based on a location determined by the location module.

4. The method of claim 2, wherein the remote computing device is configured to receive a user input indicative of a location and the remote computing device is configured to include the indication of the location in the communication based on the user input.

5. The method of claim 1, wherein the packaging material further includes a brand mark proximate to the identification tag.

6.-7. (canceled)

8. The method of claim 5, wherein at least a portion of the brand mark is visible on the packaging material and at least a portion of the identification tag is non-visible.

9. The method of claim 1, further comprising:
sending, from the one or more computing devices to the remote computing device, an indication of a past event associated with at least one of the packaging material or the product.

10. The method of claim 9, wherein the product is a food product, and wherein the past event includes one or more of a growing or raising of the food product, a harvesting of the food product, a processing of the food product, a manufacturing of the packaging material, a packaging of the food product inside the packaging material, a maximum storage temperature of the food product, or a recall of the food product.

11.-12. (canceled)

13. The method of claim 1, wherein the location-based disposal information includes instructions how to recycle the packaging material in the location associated with the remote computing device.

14. A computer readable storage medium having instructions embodied thereon for facilitating disposal of packaging material, wherein the packaging material is configured to have a product packaged therein, and wherein the packaging material includes an identification tag that includes an identifier, the instructions comprising instructions that, in response to execution by one or more computing devices, cause the one or more computing devices to:
receive, from a remote computing device, a communication that includes the identifier read by the remote computing device from the identification tag of the remote computing device;
identify a location associated with the remote computing device;
determine location-based disposal information for the packaging material that is based at least in part on the location associated with the remote computing device; and
send, to the remote computing device, an indication of the location-based disposal information for the packaging material.

15.-18. (canceled)

19. The computer readable storage medium of claim 14, wherein the location-based disposal information includes instructions how to recycle the packaging material in the location associated with the remote computing device.

20. A system for facilitating disposal of packaging material, wherein the packaging material is configured to have a product packaged therein, and wherein the packaging material includes an identification tag that includes an identifier, the system comprising:
one or more processors; and
one or more memories communicatively coupled to the one or more processors, wherein the one or more memories have instructions stored thereon that, in response to execution by the one or more processors, cause the system to:
receive, from a remote computing device, a communication that includes the identifier read by the remote computing device from the identification tag of the remote computing device,
identify a location associated with the remote computing device,
determine location-based disposal information for the packaging material that is based at least in part on the location associated with the remote computing device, and
send, to the remote computing device, an indication of the location-based disposal information for the packaging material.

21. The system of claim 20, wherein the packaging material further includes a brand mark proximate to the identification tag.

22. (canceled)

23. The system of claim 20, wherein the instructions further comprise instructions that, in response to execution by the one or more processors, further cause the system to:
send, to the remote computing device, an indication of a past event or an expected future event associated with at least one of the packaging material or the product.

24. (canceled)

25. The system of claim 20, wherein the location-based disposal information includes instructions how to recycle the packaging material in the location associated with the remote computing device.

26. A packaging material comprising:
a substrate of packaging material, wherein the packaging material is configured to have a product placed therein;
a first identification tag located on the substrate, wherein the first identification tag is machine-readable using a first manner of detection; and
a second identification tag location on the substrate, wherein the second identification tag is machine-readable using a second manner of detection;
wherein each of the first and second identification tags includes an identifier of at least one of the packaging material or the product.

27. The packaging material of claim 26, wherein:
the first manner of detection includes detection of electromagnetic energy in a first range of wavelengths, wherein the first range of wavelengths is outside of the visible range of electromagnetic energy; and
the second manner of detection includes detection of electromagnetic energy in a second range of wavelengths, wherein the second range of wavelengths is inside of the visible range of electromagnetic energy.

28. (canceled)

29. The packaging material of claim 27, wherein:
each of the first and second range of wavelengths is inside of the visible range of electromagnetic energy; and
the first range of wavelengths does not overlap the second range of wavelengths.

30.-34. (canceled)

35. The packaging material of claim 26, wherein:
the first identification tag includes information encoded in at least one of a barcode or a QR code; and
the second identification tag includes information encoded in a symbolic code having a plurality of different symbols.

36. A method of tracing packaging material, the method comprising:
providing a packaging material configured to have a product packaged therein, the packaging material including a brand mark and an identification tag, the identification tag including an identifier, and the identification tag being located on the packaging material in proximity to the brand mark;
receiving, by a computing system, a first communication from a first remote computing device, the first communication including the identifier and information about an event associated with the packaging material, and the first remote computing device being configured to send the first communication in response to reading the identification tag of the packaging material;
storing, by the computing system, the information about the event associated with the packaging material in a database;
after receiving the first communication, receiving, by the computing system, a second communication from a second remote computing device, the second communication including the identifier, the second remote computing device being configured to send the second communication in response to reading the identification tag of the packaging material, and the first and second remote computing devices being remote from each other;
in response to receiving the second communication, retrieving, by the computing system, the information about the event associated with the packaging material from the database; and
in response to retrieving the information from the database, sending, by the computing system, the information about the event associated with the packaging material to the second remote computing device.
